(19) United States
(12) Patent Application Publication
(10) Pub. No.: US 2025/0244133 A1
(43) Pub. Date: Jul. 31, 2025

(54) GENERATING SAFEST ROUTE BASED ON ROAD NETWORK CHARACTERISTICS AND OPERATIONAL MEASURES

(71) Applicant: Texas State University, San Marcos, TX (US)

(72) Inventors: Subasish Das, San Antonio, TX (US); David Mills, Spicewood, TX (US)

(21) Appl. No.: 19/032,386

(22) Filed: Jan. 20, 2025

Related U.S. Application Data
(60) Provisional application No. 63/625,204, filed on Jan. 25, 2024.

(51) Int. Cl. G01C 21/34

(52) U.S. Cl. CPC G01C 21/3461; G01C 21/3492

(57) ABSTRACT

A computer-implemented method, system, and computer program product for generating a safest route for travel. Inputs as to a starting point (e.g., home) and a destination (e.g., grocery store) are received. Road network characteristics and operational measures are obtained in connection with the starting point and the destination. Road network characteristics refer to the features or qualities regarding roadways. Operational measures refer to the features or characteristics of safety involved in traveling along the roadways. The safest route to travel to the destination is then generated using a trained machine learning model using the obtained road network characteristics and the operational measures in connection with the starting point and the destination.

### CROSS REFERENCE TO RELATED APPLICATIONS

This application claims priority to U.S. Provisional Patent Application Ser. No. 63/625,204, “Generating Safest Route Based on Road Network Characteristics and Operational Measures,” filed Jan. 25, 2024, which is incorporated by reference herein in its entirety.

### TECHNICAL FIELD

The present disclosure relates generally to route planning applications, and more particularly to a route planning application that generates the safest route based on road network characteristics and operational measures.

### BACKGROUND

A route planning application is an application that routes a user from a starting point to a destination. For example, a user may input a starting point into the route planning application, such as the home of the user, as well as input a destination, such as a grocery store.

Current route planning applications consider distance and mobility measures in generating different route options to the user based on the shortest distance and/or time.

Unfortunately, such route planning applications do not include factors, such as safety and security. That is, such route planning applications do not attempt to incorporate safety and security in generating routes for a user to travel.

Individuals want to ensure their personal safety while traveling, particularly in unfamiliar areas or during adverse conditions. Current route planning applications do not reduce the likelihood of encountering dangerous situations.

Furthermore, traffic accidents are a significant concern worldwide. While current route planning applications indicate to a user where an accident has already transpired, such current route planning applications do not generate a route that reduces the chances of encountering hazardous road conditions, high-crime areas, or accident-prone intersections thereby aiming to decrease the risk of collisions.

Additionally, users may be concerned about their safety in specific neighborhoods or regions known for higher crime rates. Such current route planning applications do not generate routes that help users avoid areas with a higher likelihood of criminal activity thereby enhancing their personal security.

### SUMMARY

In one embodiment of the present disclosure, a computer-implemented method for generating a safest route for travel comprises receiving an input as to a starting point and a destination. The method further comprises obtaining road network characteristics and operational measures in connection with the starting point and the destination. The method additionally comprises generating the safest route to travel to the destination using a trained machine learning model using the obtained road network characteristics and the operational measures in connection with the starting point and the destination.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 is a diagram of the software components used by the vehicle safety system to build and train a machine learning model to identify a safest route to travel in accordance with an embodiment of the present disclosure;

FIG. 3 illustrates the basic components of the smartphone device in accordance with an embodiment of the present disclosure;

FIG. 4 illustrates an embodiment of the present disclosure of the hardware configuration of the vehicle safety system and the smartphone device which is representative of a hardware environment for practicing the present disclosure;

FIG. 5 is a flowchart of a method for training a machine learning model to identify a safest route to travel in accordance with an embodiment of the present disclosure; and

FIG. 6 is a flowchart of a method for generating a safest route to travel using the trained machine learning model in accordance with an embodiment of the present disclosure.

### DETAILED DESCRIPTION

As stated above, a route planning application is an application that routes a user from a starting point to a destination. For example, a user may input a starting point into the route planning application, such as the home of the user, as well as input a destination, such as a grocery store.

Current route planning applications consider distance and mobility measures in generating different route options to the user based on the shortest distance and/or time.

Unfortunately, such route planning applications do not include factors, such as safety and security. That is, such route planning applications do not attempt to incorporate safety and security in generating routes for a user to travel.

Individuals want to ensure their personal safety while traveling, particularly in unfamiliar areas or during adverse conditions. Current route planning applications do not reduce the likelihood of encountering dangerous situations.

Furthermore, traffic accidents are a significant concern worldwide. While current route planning applications indicate to a user where an accident has already transpired, such current route planning applications do not generate a route that reduces the chances of encountering hazardous road conditions, high-crime areas, or accident-prone intersections thereby aiming to decrease the risk of collisions.

Additionally, users may be concerned about their safety in specific neighborhoods or regions known for higher crime rates. Such current route planning applications do not generate routes that help users avoid areas with a higher likelihood of criminal activity thereby enhancing their personal security.

The embodiments of the present disclosure provide a means for a route planning application that generates the safest route based on road network characteristics and operational measures. In one embodiment, a machine learning model is built and trained to identify a safest route to travel. Upon building and training such a machine learning model, an application, such as on a smartphone device, receives input as to a starting point (e.g., home) and a destination (e.g., grocery store). Upon obtaining road network characteristics and operational measures in connection with the starting point and destination, the application generates the safest route to travel to the destination using the trained machine learning model using the obtained road network characteristics and operational measures in connection with the starting point and destination. A further discussion regarding these and other features is provided below.

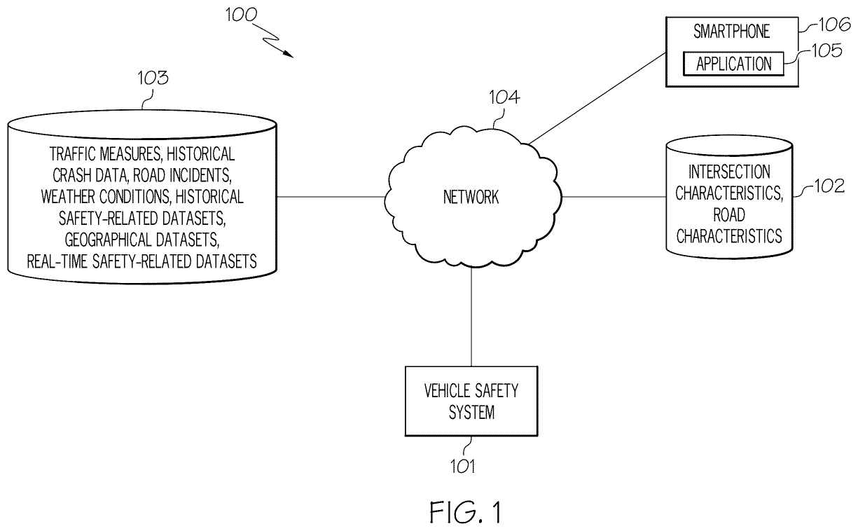

Referring now to the Figures in detail, FIG. 1 illustrates an embodiment of the present disclosure of a communication system 100 for practicing the principles of the present disclosure. Communication system 100 includes a vehicle safety system 101 connected to databases 102, 103 via a network 104.

Vehicle safety system 101 is configured to build and train a mathematical model configured to generate a safest route for travel. Upon building and training such a machine learning model, an application (app) 105, such as on smartphone device 106 connected to network 104, receives input as to a starting point (e.g., home) and a destination (e.g., grocery store). Upon obtaining road network characteristics and operational measures in connection with the starting point and destination, such as from databases 102, 103, application 105 generates the safest route to travel to the destination using the trained machine learning model using the obtained road network characteristics and operational measures from databases 102, 103 in connection with the starting point and destination.

In one embodiment, vehicle safety system 101 builds and trains a mathematical model configured to generate a safest route for travel using road network characteristics from database 102, such as intersection characteristics and road characteristics. Road network characteristics, as used herein, refer to the features or qualities regarding roadways.

In one embodiment, vehicle safety system 101 builds and trains the mathematical model configured to generate a safest route for travel using operational measures from database 103, such as traffic measures, historical crash data, road incidents, and weather conditions. Operational measures, as used herein, refer to the features or characteristics of safety involved in traveling along the roadways.

Furthermore, in one embodiment, the mathematical model is configured to generate the safest route for travel based on generating safety probability scores on different routes, including in real-time. A “safety probability score,” as used herein, refers to a score corresponding to a level of safety, such as safety from encountering hazardous road conditions, high-crime areas, accident-prone intersections, dangerous situations, criminal activity, etc. In one embodiment, such scores are normalized between a value of 0 and 1, with 1 being the highest level of safety and 0 being the lowest level of safety. In one embodiment, the route assigned with the highest level of safety (e.g., assigned the highest safety probability score) corresponds to the route selected by the mathematical model to travel.

In one embodiment, such scores are based on risks (e.g., pedestrian/cyclist crash risk, crime risk, vehicle crash risk, health risk (risk to health, such as from air pollution, stress from congestion, etc.), and the hazardous materials transportation risk (e.g., risk of spillage of hazardous materials, etc.)) using data obtained from operational measures of database 103. In one embodiment, such risks may be formulated by analyzing data stored in database 103, including historical safety-related datasets from database 103, geographical datasets from database 103, and real-time safety-related datasets from database 103.

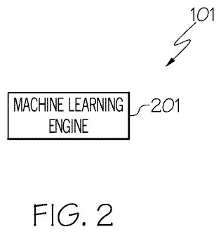

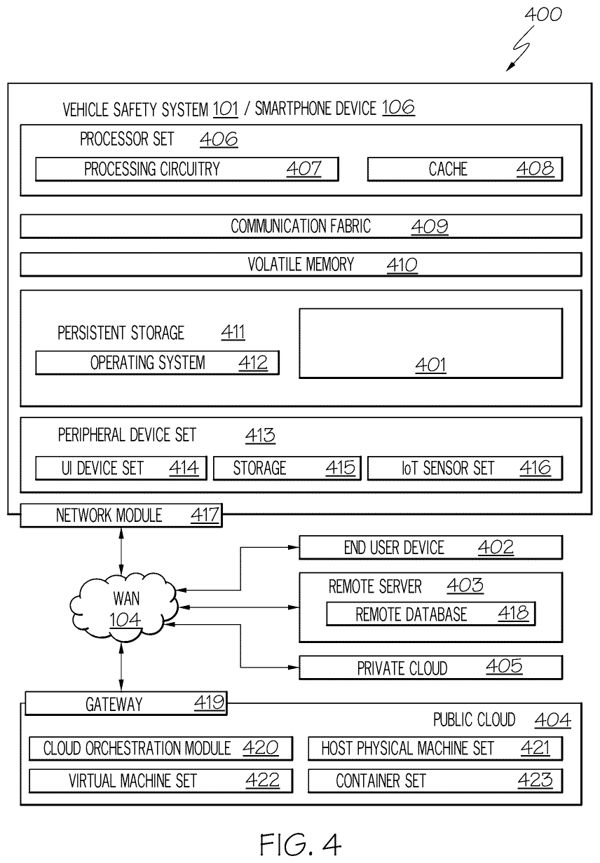

A description of the software components of vehicle safety system 101 used for building and training a machine learning model to generate the safest route for travel is provided below in connection with FIG. 2. A description of the hardware configuration of vehicle safety system 101 is provided further below in connection with FIG. 4.

As discussed above, the user of smartphone device 106 inputs a starting point (e.g., home) and a destination (e.g., grocery store). In one embodiment, the user inputs such locations via various means, such as via a graphical user interface of smartphone device 106, a keyboard of smartphone device 106, etc.

In one embodiment, smartphone device 106 obtains road network characteristics and operational measures in connection with the starting point and destination, such as from databases 102, 103. Such information may then be utilized by application 105, such as a route planning application, to generate the safest route to travel to the destination using the trained machine learning model using the obtained road network characteristics and operational measures from databases 102, 103, respectively, in connection with the starting point and destination. In one embodiment, application 105 is embedded in a navigation system.

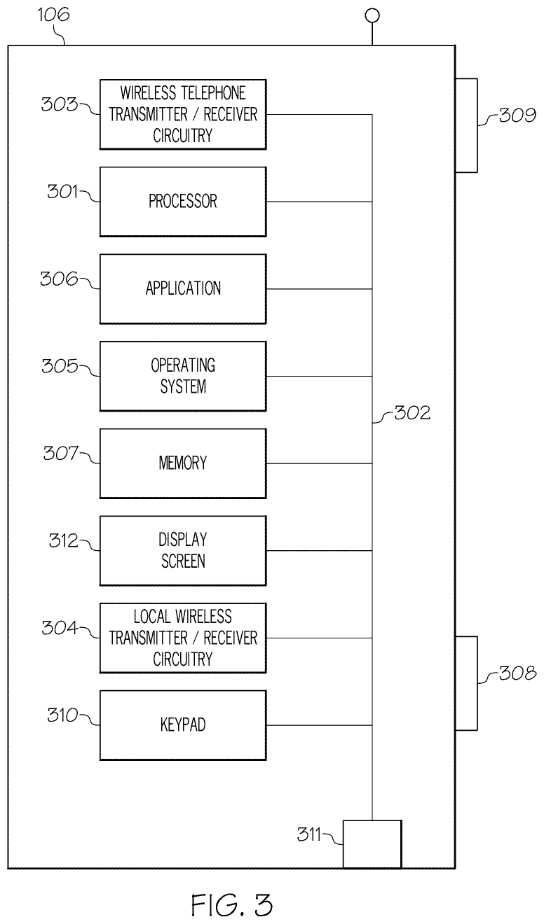

A description of the basic components of smartphone device 106 is provided further below in connection with FIG. 3. Furthermore, a description of the hardware configuration of smartphone device 106 is provided further below in connection with FIG. 4.

As illustrated in FIG. 1, the components of system 100, such as smartphone device 106, databases 102, 103 and vehicle safety system 101 may be interconnected via network 104.

Network 104 may be, for example, a local area network, a wide area network, a wireless wide area network, a circuit-switched telephone network, a Global System for Mobile communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of vehicle safety systems 101, databases 102, 103, networks 104, applications 105, and smartphone devices 106.

A discussion regarding the software components used by vehicle safety system 101 for building and training a machine learning model to identify a safest route to travel is provided below in connection with FIG. 2.

FIG. 2 is a diagram of the software components used by vehicle safety system 101 to build and train a machine learning model to identify a safest route to travel in accordance with an embodiment of the present disclosure.

Referring to FIG. 2, in conjunction with FIG. 1, vehicle safety system 101 includes a machine learning engine 201 configured to build and train a machine learning model for generating the safest route for travel.

In one embodiment, machine learning engine 201 uses a machine learning algorithm (e.g., supervised learning) to build and train a machine learning model for generating the safest route for travel. That is, machine learning engine 201 uses a machine learning algorithm (e.g., supervised learning) to build and train a machine learning model for generating the safest route for travel using a sample data set consisting of road network characteristics and operational measures in connection with a starting point and a destination.

Road network characteristics, as used herein, refer to the features or qualities regarding roadways. Examples of road network characteristics include, but not limited to, intersection characteristics and road characteristics.

Intersection characteristics, as used herein, refer to the features or qualities regarding intersection performance for motor vehicles, including, but not limited to, type of traffic control, vehicular capacity of the intersection, which may be determined from the number of lanes and traffic control (although there are other factors), ability to make turning movements, and visibility of approaching and crossing pedestrians and bicycles. In one embodiment, such intersection characteristics are populated in database 102 by an expert.

Road characteristics, as used herein, refer to the features or qualities of the conditions of the road, such as general surface conditions, road geometry, markings, etc. In one embodiment, such road characteristics are monitored or measured by sensors, such as sensors placed alongside, above, or below the roadways (e.g., sensors manufactured by Einride®, Vivacity Labs, RoadBotics®, AIWaysion, etc.), which are used to populated database 102.

In one embodiment, road characteristics include the speed, vehicle length, and vehicle counts obtained by passive infrared detectors placed along, above, or below the roadways (e.g., sensors manufactured by Einride®, Vivacity Labs, RoadBotics®, AIWaysion, etc.), which are used to populate database 102.

In one embodiment, such road characteristics are acquired via over-roadway laser radar sensors, which transmit multiple beams for accurate measurement of vehicle position, speed, and class, which are used to populate database 102.

In one embodiment, vehicle safety system 101 builds and trains the mathematical model configured to generate a safest route for travel using operational measures from database 103, such as traffic measures, historical crash data, road incidents, and weather conditions.

Operational measures, as used herein, refer to the features or characteristics of safety involved in traveling along the roadways.

Traffic measures, as used herein, refer to physical designs and other measures put in place on existing roads, such as to reduce vehicle speeds, improve safety for pedestrians and cyclists, etc. For example, vertical deflections (e.g., speed humps, speed tables, and raised intersections), horizontal shifts, and roadway narrowing may be utilized to reduce speed and enhance the street environment for non-motorists. Closures that obstruct traffic movements in one or more directions, such as median barriers, are intended to reduce cut-through traffic. In one embodiment, such traffic measures are monitored or detected by sensors, such as sensors placed alongside, above, or below the roadways (e.g., sensors manufactured by Einride®, Vivacity Labs, RoadBotics®, AIWaysion, etc.), which are used to populate database 103. In one embodiment, such traffic measures are populated in database 103 by an expert.

Historical crash data, as used herein, refers to data pertaining to vehicle collisions, accidents, etc. In one embodiment, such historical crash data is obtained from Fatality Analysis Reporting Systems (FARS) and historical crash data publicly available from different states. In one embodiment, such historical crash data is populated in database 103 by an expert.

Weather conditions, as used herein, refer to weather during a defined time period ranging from hours to several weeks. Examples of weather conditions including thunderstorms, fog, sunshine, cloudiness, snow, freezing rain, overcast, sleet, windy, rainy, etc. In one embodiment, such weather conditions are obtained from a weather service, such as the National Oceanic and Atmospheric Administration (NOAA), which is used to populate database 103.

Furthermore, in one embodiment, the mathematical model is configured to generate the safest route for travel based on generating safety probability scores on different routes, including in real-time. A “safety probability score,” as used herein, refers to a score corresponding to a level of safety, such as safety from encountering hazardous road conditions, high-crime areas, accident-prone intersections, dangerous situations, criminal activity, etc. In one embodiment, such scores are normalized between a value of 0 and 1, with 1 being the highest level of safety and 0 being the lowest level of safety. In one embodiment, the route assigned with the highest level of safety (e.g., assigned the highest safety probability score) corresponds to the route selected by the mathematical model to travel.

In one embodiment, such scores are based on risks (e.g., pedestrian/cyclist crash risk, crime risk, vehicle crash risk, health risk (risk to health, such as from air pollution, stress from congestion, etc.), and the hazardous materials transportation risk (e.g., risk of spillage of hazardous materials, etc.)) using data obtained from operational measures of database 103. In one embodiment, such risks may be formulated by analyzing data stored in database 103, including historical safety-related datasets from database 103, geographical datasets from database 103, and real-time safety-related datasets from database 103.

The historical safety-related datasets, as used herein, refer to datasets that include vehicle crash information, crime information, transportation information, such as the transportation of hazardous materials, etc. that relates to the safety of travel. In one embodiment, crash information pertaining to vehicle collisions, accidents, etc. is obtained from the National Safety Council (NSC), which is used to populate database 103. In one embodiment, crime information is obtained from the National Crime Information Center, which is used to populate database 103. In one embodiment, transportation information, such as the transportation of hazardous materials, is obtained from the Federal Motor Carrier Safety Administration, which is used to populate database 103.

Geographical datasets, as used herein, refer to the locations of crashes obtained from the crash information, the locations of crime obtained from the crime information, and the locations of transportation, such as the locations of transporting hazardous materials obtained from the transportation information. In one embodiment, such locations obtained from such sources are used to populate database 103.

Real-time safety-related datasets, as used herein, refer to the safety information obtained in real-time, such as crash information, crime information, transportation information, etc., which is used to populate database 103.

In one embodiment, the mathematical model is configured to generate the safest route for travel based on generating safety probability scores on different routes between a designated starting location and a designated destination. In one embodiment, such scores are generated based on the risks (e.g., pedestrian/cyclist crash risk, crime risk, vehicle crash risk, health risk (risk to health, such as from air pollution, stress from congestion, etc.), and the hazardous materials transportation risk (e.g., risk of spillage of hazardous materials, etc.)) associated with such routes using data (e.g., historical safety-related datasets, geographical datasets, real-time safety-related datasets, etc.) obtained from the operational measures of database 103. In one embodiment, such risks are based on the datasets discussed above that are accessed for the routes in question. In one embodiment, the higher the risks, the lower the safety probability score and vice-versa.

The sample dataset discussed above, which includes road network characteristics, operational measures, historical safety-related datasets, geographical datasets, and real-time safety-related datasets, is referred to herein as the “training data,” which is used by the machine learning algorithm to make predictions or decisions as to safest route for traveling. The algorithm iteratively makes predictions on the training data as to the safest route for traveling until the predictions achieve the desired accuracy as determined by an expert. Examples of such learning algorithms include nearest neighbor, Naïve Bayes, decision trees, linear regression, support vector machines, and neural networks.

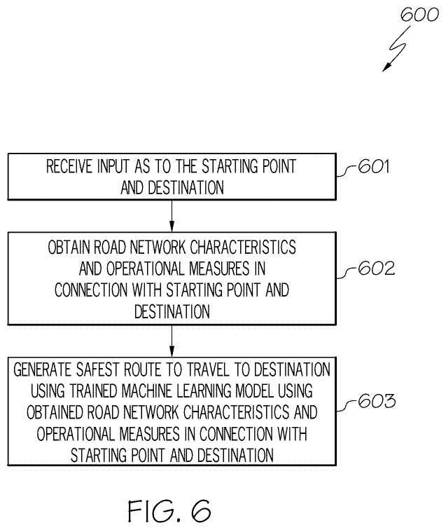

Upon training the machine learning model to generate the safest route for traveling, the machine learning model is utilize to generate a safest route for travel upon the user of smartphone device 106 inputting a starting point (e.g., home) and a destination (e.g., grocery store) as discussed further below in connection with FIG. 6.

In one embodiment, machine learning engine 201 trains the machine learning model to be utilized by application 105 to inform the user of smartphone device 106 about the safety of alternative routes between the desired starting point and destination. Road crashes are rare events subject to temporal instability, which implies the limitations of solely relying on historical data for estimating the risk of crashes. Also, the risk of crashes is associated with roadway characteristics, weather conditions, user behavior, and traffic conditions, which can change over time. As such, safe route-finding needs to account for the changes in determinants of crashes during the trip and provide insights into the future for both route-finding and detouring. In one embodiment, application 105 is designed as a dynamic, predictive algorithm. The dynamic, predictive algorithm of the present disclosure provides a robust prediction of the risk of crashes in real-time data.

In one embodiment, application 105 utilizes crash prediction models. In one embodiment, crash prediction models are founded on the assumption that crash events follow a binary trial, and for a large number of vehicles, the incidents can be modeled by the Poisson process. The distribution of crashes during a specific period of time is drawn from a negative binomial distribution, where the expected value of the distribution function represents the expected number of crashes at a specific road segment. These models consider the aggregated environmental, behavioral, and traffic information for estimating the expected number of crashes.

In one embodiment, vehicle-level models are utilized by application 105 to consider user-specific factors in route selection, namely, driving experience, driver background, and vehicle characteristics, that can elevate the reliability of risk estimations. In one embodiment, due to challenges in the availability and quality of crash databases, surrogate safety measures (e.g., time to collision and traffic conflicts) are used as a proxy for road safety.

As previously discussed, in one embodiment, databases 102, 103 include data used for assessing safety in road navigation, namely road network or road inventory database 102, and database 103 on operational measures (e.g., operating speed, travel time, historical crash or event information on the roadway segment).

TABLE 1
shown below, lists the key data elements and potential
sources for each of these data elements.
Example data sources for safe route-finding.

| Data Elements | Data Source |
|---|---|
| Speed Measures | |
| Posted speed limit or travel time | State DOT, HERE, |
| Avg, operating speed, percentile speed, & | SHRP 2-RID |
| speed variance | State DOT, INRIX, |
| Continuous 5-minute, 15-minute, hourly, | INRIX XD, HERE, |
| daily, monthly & annual speed | NPMRDS |
| Vehicle trajectory dam or waypoint data | INRIX, Wejo, StreetLight |
| Percent of vehicles exceeding speed limit | Saate DOT |
| Roadway Inventory Data | |
| Segment length | State DOT, HPMS, |
| Number of lanes | SHRP2-RID, |
| Shoulder and lane width | GoogleEarth |
| Horizontal and vertical alignment | |
| Median barrier | |
| Roadside fixed objects (barrier, guardrail, | |
| poles) | |
| Traffic control devices, pavement condition | |
| Weather Characteristics | |
| Continuous hourly, daily, monthly and | NOAA, Road |
| annual precipitation & visibility data. | Weather Information |
| | System (RWIS) |
| Traffic Volume Measures | |
| AADT | State DOT, TMAS, |
| | HPMS, SHRP2. |
| | RID, StreetLight Data Inc. |
| Hourly traffic volume | TMAS, StreetLight |
| Crash Measures | |
| Crash time and date | State DOT, HSIS, |
| Crash location | SHRP2-RID |
| Crash type and severity | |
| Crash contributing factors (e.g., speeding) | |
| Lighting and weather conditions | |
| Real-Time Traffic Data for the U.S. | |
| 1.70 million cases (2016-2019) | MapQuest Traffic Application |
| [every 90 s] | Programming Interface (API) |
| 0.54 million cases (2016-2019) | Bing Map Traffic API |
| [every 90 s] | |
| Real-Time Incident Data | |
| Crowdsourced data | Waze |

In one embodiment, roadway inventory data from database 102 contains information of roadway features (e.g., segment length, roadbed width, median type, shoulder type, shoulder width). In one embodiment, the roadway features are provided in separate layers. In one embodiment, database 102 is populated using state databases. In one embodiment, database 102 is populated using OpenStreetMap and other private data vendors (e.g., HERE, INRIX) to obtain geometric data that is not provided by state databases, such as super elevation, curve radius, and posted speed limits.

For operation measures stored in database 103, travel time/traffic volume-related features, and recurrent/non-recurrent event-related features (e.g., road incidents) are populated in database 103.

In one embodiment, database 103 is populated from various sources, including, but not limited to, Departments of Transportation (DOT), the Highway Performance Monitoring System (HPMS), the Highway Safety Information System (HSIS), the Roadway Inventory Database (RID) and the companion Naturalistic Driving Study (NDS) data (from the 2nd Strategic Highway Research Program or SHRP2), Traffic Monitoring Analysis Systems (TMAS), and National Performance Management Research Data Set (NPMRDS). In one embodiment, database 103 is populated from commercial private data vendors including, but not limited to, HERE, INRIX, Wejo, and StreetLight.

In one embodiment, the data elements include trajectory, wiper usage, acceleration, deceleration, hard braking, sudden stoppage, and near collision. While some of the data sources discussed above can report real-time data (to support a dynamic algorithm), MapQuest® and Bing® Map Traffic AI may be used to acquire real-time traffic data. In one embodiment, crowdsourced databases, such as Waze®, are potential sources for real-time incidents. Table 1 lists some of the key data elements and related data sources.

A discussion regarding the basic components of smartphone device 106 is provided below in connection with FIG. 3.

FIG. 3 illustrates the basic components of smartphone device 106 in accordance with an embodiment of the present disclosure.

Referring to FIG. 3, smartphone device 106 has a processor 301 connected to various other components by a system bus 302.

Smartphone device 106 further includes transmitter/receiver circuitry 303 configured to wirelessly send and receive signals to and from network 104 (FIG. 1). Smartphone device 106 also includes local wireless transmitter/receiver circuitry 304 configured to wirelessly send and receive short range signals, such as Bluetooth, infrared or Wi-Fi.

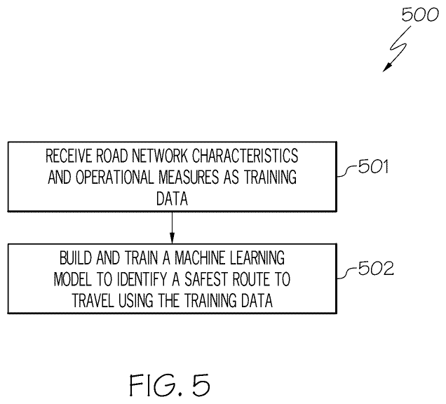

Smartphone device 106 further includes an operating system 305 that runs on processor 301 and provides control and coordinates the functions of the various components of FIG. 3. An application 306 in accordance with the principles of the present disclosure runs in conjunction with operating system 305 and provides calls to operating system 305 where the calls implement the various functions or services to be performed by application 306. Application 306 of smartphone device 106 may include, for example, a program for generating a safest route for travel using a trained machine learning model as discussed further below in connection with FIGS. 5-6. In such an embodiment, application 306 corresponds to application 105 of FIG. 1.

Smartphone device 106 further includes a memory 307 that is configured to store the requisite logic and parameters to control the transmitter/receiver circuitry 303, 304 and control the other functions of smartphone device 106. Memory 307 is generally integrated as part of the mobile device circuitry, but may, in some embodiments, include a removable memory, such as a removable disk memory, integrated circuit (IC) memory, a memory card, or the like. Processor 301 and memory 307 also implement the logic and store the settings, preferences, and parameters for smartphone device 106. It should be noted that software components including operating system 305 and application 306 may be loaded into memory 307, which may be smartphone device's 106 main memory for execution.

Smartphone device 106 also has a microphone 308 and speaker 309 for the user to speak and listen to callers. Speaker 309 may represent multiple speakers, at least some of which are configured to alert the user to incoming calls or messages. A keypad 310 is configured as part of smartphone device 106 for dialing telephone numbers and entering data. Smartphone device 106 may be configured with a data input/output (I/O) port 311 for downloading data, applications, programs, and other information. In addition, smartphone device 106 typically includes a display screen 312 for displaying messages and information about incoming calls or other features of smartphone device 106 that use a graphic display.

A discussion regarding the hardware configuration of vehicle safety system 101 and smartphone device 106 is provided below in connection with FIG. 4.

FIG. 4 illustrates an embodiment of the present disclosure of the hardware configuration of vehicle safety system 101/smartphone device 106 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code (stored in block 401) involved in performing the inventive methods, such as generating a safest route for travel. In addition to block 401, computing environment 400 includes, for example, vehicle safety system 101/smartphone device 106, network 104, such as a wide area network (WAN), end user device (EUD) 402, remote server 403, public cloud 404, and private cloud 405. In this embodiment, vehicle safety system 101/smartphone device 106 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Vehicle safety system 101/smartphone device 106 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically vehicle safety system 101/smartphone device 106, to keep the presentation as simple as possible. Vehicle safety system 101/smartphone device 106 may be located in a cloud, even though it is not shown in a cloud in FIG. 4. On the other hand, vehicle safety system 101/smartphone device 106 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto vehicle safety system 101/smartphone device 106 to cause a series of operational steps to be performed by processor set 406 of vehicle safety system 101/smartphone device 106 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 408 and the other storage media discussed below. The program instructions, and associated data, are accessed by processor set 406 to control and direct performance of the inventive methods. In computing environment 400, at least some of the instructions for performing the inventive methods may be stored in block 401 in persistent storage 411.

Communication fabric 409 is the signal conduction paths that allow the various components of vehicle safety system 101/smartphone device 106 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In vehicle safety system 101/smartphone device 106, the volatile memory 410 is located in a single package and is internal to vehicle safety system 101/smartphone device 106, but, alternatively or additionally, the volatile memory may be distributed over multiple packages and/or located externally with respect to vehicle safety system 101/smartphone device 106.

Persistent Storage 411 is any form of non-volatile storage for computers that is now known or to be developed in the future. The non-volatility of this storage means that the stored data is maintained regardless of whether power is being supplied to vehicle safety system 101/smartphone device 106 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the inventive methods.

Peripheral device set 413 includes the set of peripheral devices of vehicle safety system 101/smartphone device 106. Data communication connections between the peripheral devices and the other components of vehicle safety system 101/smartphone device 106 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where vehicle safety system 101/smartphone device 106 is required to have a large amount of storage (for example, where vehicle safety system 101/smartphone device 106 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows vehicle safety system 101/smartphone device 106 to communicate with other computers through WAN 104. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the inventive methods can typically be downloaded to vehicle safety system 101/smartphone device 106 from an external computer or external storage device through a network adapter card or network interface included in network module 417.

WAN 104 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates vehicle safety system 101/smartphone device 106), and may take any of the forms discussed above in connection with vehicle safety system 101/smartphone device 106. EUD 402 typically receives helpful and useful data from the operations of vehicle safety system 101/smartphone device 106. For example, in a hypothetical case where vehicle safety system 101/smartphone device 106 is designed to provide a recommendation to an end user, this recommendation would typically be communicated from network module 417 of vehicle safety system 101/smartphone device 106 through WAN 104 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to vehicle safety system 101/smartphone device 106. Remote server 403 may be controlled and used by the same entity that operates vehicle safety system 101/smartphone device 106. Remote server 403 represents the machine(s) that collect and store helpful and useful data for use by other computers, such as vehicle safety system 101/smartphone device 106. For example, in a hypothetical case where vehicle safety system 101/smartphone device 106 is designed and programmed to provide a recommendation based on historical data, then this historical data may be provided to vehicle safety system 101/smartphone device 106 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 104 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed herein to generate a safest route for travel. In one embodiment, such components may be implemented in hardware. The functions discussed above performed by such components are not generic computer functions. As a result, vehicle safety system 101/smartphone device 106 is a particular machine that is the result of implementing specific, non-generic computer functions.

In one embodiment, the functionality of such software components of vehicle safety system 101/smartphone device 106, including the functionality for generating a safest route for travel, may be embodied in an application specific integrated circuit.

As stated above, current route planning applications consider distance and mobility measures in generating different route options to the user based on the shortest distance and/or time. Unfortunately, such route planning applications do not include factors, such as safety and security. That is, such route planning applications do not attempt to incorporate safety and security in generating routes for a user to travel. Individuals want to ensure their personal safety while traveling, particularly in unfamiliar areas or during adverse conditions. Current route planning applications do not reduce the likelihood of encountering dangerous situations. Furthermore, traffic accidents are a significant concern worldwide. While current route planning applications indicate to a user where an accident has already transpired, such current route planning applications do not generate a route that reduces the chances of encountering hazardous road conditions, high-crime areas, or accident-prone intersections thereby aiming to decrease the risk of collisions. Additionally, users may be concerned about their safety in specific neighborhoods or regions known for higher crime rates. Such current route planning applications do not generate routes that help users avoid areas with a higher likelihood of criminal activity thereby enhancing their personal security.

The embodiments of the present disclosure provide a means for a route planning application that generates the safest route to travel based on road network characteristics and operational measures as discussed below in connection with FIGS. 5-6. FIG. 5 is a flowchart of a method for training a machine learning model to identify a safest route to travel. FIG. 6 is a flowchart of a method for generating a safest route to travel using the trained machine learning model.

As stated above, FIG. 5 is a flowchart of a method 500 for training a machine learning model to identify a safest route to travel in accordance with an embodiment of the present disclosure.

Referring to FIG. 5, in conjunction with FIGS. 1-4, in step 501, vehicle safety system 101 receives road network characteristics and operational measures as training data. In one embodiment, such road network characteristics and operational measures are obtained from databases 102, 103, respectively.

In step 502, vehicle safety system 101 builds and trains a machine learning model to identify a safest route to travel using the training data.

As stated above, vehicle safety system 101 includes a machine learning engine 201 configured to build and train a machine learning model for generating the safest route for travel.

In one embodiment, machine learning engine 201 uses a machine learning algorithm (e.g., supervised learning) to build and train a machine learning model for generating the safest route for travel. That is, machine learning engine 201 uses a machine learning algorithm (e.g., supervised learning) to build and train a machine learning model for generating the safest route for travel using a sample data set consisting of road network characteristics and operational measures in connection with a starting point and a destination.

Road network characteristics, as used herein, refer to the features or qualities regarding roadways. Examples of road network characteristics include, but not limited to, intersection characteristics, and road characteristics.

Intersection characteristics, as used herein, refer to the features or qualities regarding intersection performance for motor vehicles, including, but not limited to, type of traffic control, vehicular capacity of the intersection, which may be determined from the number of lanes and traffic control (although there are other factors), ability to make turning movements, and visibility of approaching and crossing pedestrians and bicycles. In one embodiment, such intersection characteristics are populated in database 102 by an expert.

Road characteristics, as used herein, refer to the features or qualities of the conditions of the road, such as general surface conditions, road geometry, markings, etc. In one embodiment, such road characteristics are monitored or measured by sensors, such as sensors placed alongside, above, or below the roadways (e.g., sensors manufactured by Einride®, Vivacity Labs, RoadBotics®, AIWaysion, etc.), which are used to populated database 102.

In one embodiment, road characteristics include the speed, vehicle length, and vehicle counts obtained by passive infrared detectors placed along, above, or below the roadways (e.g., sensors manufactured by Einride®, Vivacity Labs, RoadBotics®, AIWaysion, etc.), which are used to populate database 102.

In one embodiment, such road characteristics are acquired via over-roadway laser radar sensors, which transmit multiple beams for accurate measurement of vehicle position, speed, and class, which are used to populate database 102.

In one embodiment, vehicle safety system 101 builds and trains the mathematical model configured to generate a safest route for travel using operational measures from database 103, such as traffic measures, historical crash data, road incidents, and weather conditions.

Operational measures, as used herein, refer to the features or characteristics of safety involved in traveling along the roadways.

Traffic measures, as used herein, refer to physical designs and other measures put in place on existing roads, such as to reduce vehicle speeds, improve safety for pedestrians and cyclists, etc. For example, vertical deflections (e.g., speed humps, speed tables, and raised intersections), horizontal shifts, and roadway narrowing may be utilized to reduce speed and enhance the street environment for non-motorists. Closures that obstruct traffic movements in one or more directions, such as median barriers, are intended to reduce cut-through traffic. In one embodiment, such traffic measures are monitored or detected by sensors, such as sensors placed alongside, above, or below the roadways (e.g., sensors manufactured by Einride®, Vivacity Labs, RoadBotics®, AIWaysion, etc.), which are used to populate database 103. In one embodiment, such traffic measures are populated in database 103 by an expert.

Historical crash data, as used herein, refers to data pertaining to vehicle collisions, accidents, etc. In one embodiment, such historical crash data is obtained from the National Safety Council (NSC). In one embodiment, such historical crash data is populated in database 103 by an expert.

Weather conditions, as used herein, refer to weather during a defined time period ranging from hours to several weeks. Examples of weather conditions including thunderstorms, fog, sunshine, cloudiness, snow, freezing rain, overcast, sleet, windy, rainy, etc. In one embodiment, such weather conditions are obtained from a weather service, such as the National Weather Service, which is used to populate database 103.

Furthermore, in one embodiment, the mathematical model is configured to generate the safest route for travel based on generating safety probability scores on different routes, including in real-time. A “safety probability score,” as used herein, refers to a score corresponding to a level of safety, such as safety from encountering hazardous road conditions, high-crime areas, accident-prone intersections, dangerous situations, criminal activity, etc. In one embodiment, such scores are normalized between a value of 0 and 1, with 1 being the highest level of safety and 0 being the lowest level of safety. In one embodiment, the route assigned with the highest level of safety (e.g., assigned the highest safety probability score) corresponds to the route selected by the mathematical model to travel.

In one embodiment, such scores are based on risks (e.g., pedestrian/cyclist crash risk, crime risk, vehicle crash risk, health risk (risk to health, such as from air pollution, stress from congestion, etc.), and the hazardous materials transportation risk (e.g., risk of spillage of hazardous materials, etc.)) using data obtained from operational measures of database 103. In one embodiment, such risks may be formulated by analyzing data stored in database 103, including historical safety-related datasets from database 103, geographical datasets from database 103, and real-time safety-related datasets from database 103.

The historical safety-related datasets, as used herein, refer to datasets that include vehicle crash information, crime information, transportation information, such as the transportation of hazardous materials, etc. that relates to the safety of travel. In one embodiment, crash information pertaining to vehicle collisions, accidents, etc. is obtained from the National Safety Council (NSC), which is used to populate database 103. In one embodiment, crime information is obtained from the National Crime Information Center, which is used to populate database 103. In one embodiment, transportation information, such as the transportation of hazardous materials, is obtained from the Federal Motor Carrier Safety Administration, which is used to populate database 103.

Geographical datasets, as used herein, refer to the locations of crashes obtained from the crash information, the locations of crime obtained from the crime information, and the locations of transportation, such as the locations of transporting hazardous materials obtained from the transportation information. In one embodiment, such locations obtained from such sources are used to populate database 103.

Real-time safety-related datasets, as used herein, refer to the safety information obtained in real-time, such as crash information, crime information, transportation information, etc., which is used to populate database 103.

In one embodiment, the mathematical model is configured to generate the safest route for travel based on generating safety probability scores on different routes between a designated starting location and a designated destination. In one embodiment, such scores are generated based on the risks (e.g., pedestrian/cyclist crash risk, crime risk, vehicle crash risk, health risk (risk to health, such as from air pollution, stress from congestion, etc.), and the hazardous materials transportation risk (e.g., risk of spillage of hazardous materials, etc.)) associated with such routes using data (e.g., historical safety-related datasets, geographical datasets, real-time safety-related datasets, etc.) obtained from the operational measures of database 103. In one embodiment, such risks are based on the datasets discussed above that are accessed for the routes in question. In one embodiment, the higher the risks, the lower the safety probability score and vice-versa.

The sample dataset discussed above, which includes road network characteristics, operational measures, historical safety-related datasets, geographical datasets, and real-time safety-related datasets, is referred to herein as the “training data,” which is used by the machine learning algorithm to make predictions or decisions as to safest route for traveling. The algorithm iteratively makes predictions on the training data as to the safest route for traveling until the predictions achieve the desired accuracy as determined by an expert. Examples of such learning algorithms include nearest neighbor, Naïve Bayes, decision trees, linear regression, support vector machines, and neural networks.

In one embodiment, machine learning engine 201 trains the machine learning model to be utilized by application 105 to inform the user of smartphone device 106 about the safety of alternative routes between the desired starting point and destination. Road crashes are rare events subject to temporal instability, which implies the limitations of solely relying on historical data for estimating the risk of crashes. Also, the risk of crashes is associated with roadway characteristics, weather conditions, user behavior, and traffic conditions, which can change over time. As such, safe route-finding needs to account for the changes in determinants of crashes during the trip and provide insights into the future for both route-finding and detouring. In one embodiment, application 105 is designed as a dynamic, predictive algorithm. The dynamic, predictive algorithm of the present disclosure provides a robust prediction of the risk of crashes in real-time data.

Upon training the machine learning model to generate the safest route for traveling, the machine learning model is utilize to generate a safest route for transportation upon the user of smartphone device 106 inputting a starting point (e.g., home) and a destination (e.g., grocery store) as discussed further below in connection with FIG. 6.

FIG. 6 is a flowchart of a method 600 for generating a safest route to travel using the trained machine learning model in accordance with an embodiment of the present disclosure.

Referring to FIG. 6, in conjunction with FIGS. 1-5, in step 601, smartphone device 106 receives input from the user of smartphone device 106, such as the starting point and the destination.

As discussed above, the user of smartphone device 106 inputs a starting point (e.g., home) and a destination (e.g., grocery store) in smartphone device 106. In one embodiment, the user inputs such locations via various means, such as via a graphical user interface on display screen 312 of smartphone device 106, a keyboard or keypad 310 of smartphone device 106, etc.

In step 602, smartphone device 106 obtains road network characteristics and operational measures in connection with the starting point and destination, such as from databases 102, 103.

In step 603, application 105 of smartphone device 106 generates the safest route to travel to the destination using the trained machine learning model using the obtained road network characteristics and operational measures from databases 102, 103, respectively, in connection with the starting point and destination as discussed above.

As a result of the foregoing, the principles of the present disclosure enable route planning applications to generate a safest route for travel which provide various benefits including enhanced safety. By providing the option to choose the safest route, a navigation system may empower users to make informed decisions that minimize risks and promote a safer, overall travel experience.

Furthermore, by providing the safest route for travel, users may have peace of mind and reduce anxiety associated with traveling, especially in unfamiliar or potentially unsafe areas.

Additionally, the safest route option may help users avoid hazardous conditions, such as dangerous road segments, areas prone to accidents, or high-crime locations. By redirecting users away from potential risks, it decreases the likelihood of encountering dangerous situations and their associated consequences.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for generating a safest route for travel, the method comprising:
receiving an input as to a starting point and a destination;
obtaining road network characteristics and operational measures in connection with said starting point and said destination; and
generating said safest route to travel to said destination using a trained machine learning model using said obtained road network characteristics and said operational measures in connection with said starting point and said destination.

2. The method as recited in claim 1, wherein said machine learning model is built and trained using a training set of data containing road network characteristics and operational measures.

3. The method as recited in claim 1, wherein said road network characteristics and said operational measures are obtained from one or more databases.

4. The method as recited in claim 1, wherein said road network characteristics comprise data pertaining to intersection characteristics and road characteristics.

5. The method as recited in claim 1, wherein said operational measures comprise data pertaining to aggregated traffic measures, real-time traffic measures, historical crash data, road incidents, and weather conditions.

6. The method as recited in claim 1 further comprising:
generating safety probability scores on different routes between said starting point and said destination, wherein said safety probability scores correspond to a level of safety.

7. The method as recite in claim 6, wherein said safety probability scores are generated based on pedestrian/cyclist crash risk, crime risk, vehicle crash risk, health risk, and hazardous materials transportation risk.

8. A computer program product for generating a safest route for travel, the computer program product comprising one or more computer readable storage mediums having program code embodied therewith, the program code comprising programming instructions for:
receiving an input as to a starting point and a destination;
obtaining road network characteristics and operational measures in connection with said starting point and said destination; and
generating said safest route to travel to said destination using a trained machine learning model using said obtained road network characteristics and said operational measures in connection with said starting point and said destination.

9. The computer program product as recited in claim 8, wherein said machine learning model is built and trained using a training set of data containing road network characteristics and operational measures.

10. The computer program product as recited in claim 8, wherein said road network characteristics and said operational measures are obtained from one or more databases.

11. The computer program product as recited in claim 8, wherein said road network characteristics comprise data pertaining to intersection characteristics and road characteristics.

12. The computer program product as recited in claim 8, wherein said operational measures comprise data pertaining to aggregated traffic measures, real-time traffic measures, historical crash data, road incidents, and weather conditions.

13. The computer program product as recited in claim 8, wherein the program code further comprises the programming instructions for:
generating safety probability scores on different routes between said starting point and said destination, wherein said safety probability scores correspond to a level of safety.

14. The computer program product as recite in claim 13, wherein said safety probability scores are generated based on pedestrian/cyclist crash risk, crime risk, vehicle crash risk, health risk, and hazardous materials transportation risk.

15. A system, comprising:
a memory for storing a computer program for generating a safest route for travel; and
a processor connected to said memory, wherein said processor is configured to execute program instructions of the computer program comprising:
receiving an input as to a starting point and a destination;
obtaining road network characteristics and operational measures in connection with said starting point and said destination; and
generating said safest route to travel to said destination using a trained machine learning model using said obtained road network characteristics and said operational measures in connection with said starting point and said destination.

16. The system as recited in claim 15, wherein said machine learning model is built and trained using a training set of data containing road network characteristics and operational measures.

17. The system as recited in claim 15, wherein said road network characteristics and said operational measures are obtained from one or more databases.

18. The system as recited in claim 15, wherein said road network characteristics comprise data pertaining to intersection characteristics and road characteristics.

19. The system as recited in claim 15, wherein said operational measures comprise data pertaining to aggregated traffic measures, real-time traffic measures, historical crash data, road incidents, and weather conditions.

20. The system as recited in claim 15, wherein the program instructions of the computer program further comprises:
generating safety probability scores on different routes between said starting point and said destination, wherein said safety probability scores correspond to a level of safety.
